(19) United States
(12) Patent Application Publication
(10) Pub. No.: US 2019/0219860 A1
(43) Pub. Date: Jul. 18, 2019

(54) FLEXIBLE LIQUID CRYSTAL DISPLAY PANEL AND METHOD OF MAKING THE SAME

(71) Applicant: Wuhan China Star Optoelectronics Technology Co. Ltd., Wuhan, Hubei (CN)

(72) Inventors: Bingkun YIN, Wuhan, Hubei (CN); Wanting YIN, Wuhan, Hubei (CN); Cong TAN, Wuhan, Hubei (CN); Hung-ming SHEN, Wuhan, Hubei (CN)

(21) Appl. No.: 15/578,290

(22) PCT Filed: Nov. 21, 2017
(86) PCT No.: PCT/CN2017/112182

§ 371 Date: Nov. 30, 2017

(30) Foreign Application Priority Data
Nov. 15, 2017 (CN) 201711132186.6

(51) Int. Cl. G02F 1/1333; G02F 1/1339; G02F 1/1368

(52) U.S. Cl. CPC G02F 1/133305; G02F 2001/136222; G02F 1/1368; G02F 1/1339

(57) ABSTRACT

A flexible liquid crystal display panel and a method of making the same are provided. The flexible liquid crystal display panel includes a first flexible substrate, a second flexible substrate, liquid crystals, a plurality of pillar spacers disposed between the first and second flexible substrates, and a sealant disposed between the first and second flexible substrates for sealing the liquid crystals and the pillar spacers therein, two ends of the pillar spacers abutting against inner surfaces of the first and second flexible substrates, and a sub-spacer being wrapped within the sealant. The sealant and the pillar spacer can be made by the same material, which have sealing and the supporting abilities, the flexible liquid crystal display panel can maintain a uniform cell thickness after being bent. The arrangement of the pillar spacers can improve overall deformation resistance and improve the narrow viewing angle of the flexible liquid crystal display panel.

### RELATED APPLICATIONS

The present application is a National Phase of International Application Number PCT/CN2017/112182, filed Nov. 21, 2017, and claims the priority of China Application No. 201711132186.6, filed Nov. 15, 2017.

### BACKGROUND OF THE INVENTION

### 1. Field of the Invention

The present disclosure relates to a field of a flexible display technique. In particular, it related to a flexible liquid crystal display panel and a method of making the same.

### 2. The Related Arts

Flexible thin-film transistor-liquid crystal display (TFT-LCD) has the characteristics of ultra-thin, light weight, bendable and high degree of freedom of design. It serves a vast market space in wearable devices, mobile communications, television, commercials and military applications.

However, when the flexible liquid crystal display is bent or folded, the distance between the substrates in the liquid crystal display is changed, which results in the optical path length difference of the liquid crystal. In particular, the deformation of the curved corner is obvious and the viewing angle of the TFT-LCD becomes smaller, resulting in poor viewing angle contrast, also the local deformation directly aggravates the risk of tearing of the packaging material between the substrates.

### SUMMARY

In view of the deficiencies in the prior art, the present invention provides a flexible liquid crystal display panel and a method for fabricating the same, so as to improve the narrow viewing angle problem of the flexible liquid crystal display panel and the risk of tearing of the packaging material.

To achieve the above objectives, the present disclosure adopts the following technical solutions:

A flexible liquid crystal display panel, comprises a first flexible substrate, a second flexible substrate, liquid crystals, a plurality of pillar spacers disposed between the first flexible substrate and the second flexible substrate, and a sealant disposed between the first flexible substrate and the second flexible substrate for sealing the liquid crystals and the pillar spacers therein. Two ends of the pillar spacers are abutting against inner surfaces of the first flexible substrate and the second flexible substrate, and a sub-spacer is wrapped within the sealant.

As one embodiment, the sub-spacer is a spacer particle and is integrally formed with a material of the sealant, or the sub-spacer has a columnar shape and has two ends abutting against the inner surfaces of the first flexible substrate and the second flexible substrate respectively.

As one embodiment, a thin film transistor array and a color resist are disposed on a surface of the first flexible substrate facing the second flexible substrate.

As one embodiment, a radial dimension of the pillar spacer on the second flexible substrate is greater than that on the first flexible substrate.

As one embodiment, the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.

As one embodiment, the supporting unit is a rhombus or a regular polygon.

The other objective of the present disclosure is to provide a method of manufacturing a flexible liquid crystal display panel, comprising: providing a first base and a second base; respectively forming a first flexible substrate and a second flexible substrate on the first base and the second base; forming an sealing material mixed with a spacer material on the first flexible substrate to form an annular first portion on the periphery of the first flexible substrate and a plurality of second portions insides the first portion at intervals; aligning the first flexible substrate with the second flexible substrate and curing the sealing material to cure the first portion and the second portion to respectively form an sealant and a pillar spacer; injecting liquid crystals between the first flexible substrate and the second flexible substrate, and sealing an injection port; and peeling off the first base and the second base.

As one embodiment, a material of the pillar spacer is a spacer particle.

As one embodiment, the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.

The sealant and the pillar spacer of the flexible liquid crystal display panel in the present disclosure can be manufactured by the same sealing material. The sealant and the pillar spacer have both sealing ability and supporting ability, so that the flexible liquid crystal display panel can keep a uniform cell thickness after being bent, and there is no risk of tearing in the edge of the sealant. In addition, the arrangement of the pillar can improve the anti-deformation ability of the whole flexible liquid crystal display panel, as well as improve the narrow viewing angle of the flexible liquid crystal display panel.

### BRIEF DESCRIPTION OF THE DRAWINGS

FIG. 1 is a partial structural schematic diagram of a flexible liquid crystal display panel according to an embodiment of the present disclosure;

FIG. 2 is a partial schematic structural diagram of another flexible liquid crystal display panel according to an embodiment of the present disclosure;

FIG. 3 is a structural schematic diagram of the internal structure of a flexible liquid crystal display panel according to an embodiment of the present disclosure;

FIG. 4 is a structural schematic diagram of the internal structure of another flexible liquid crystal display panel according to an embodiment of the present disclosure;

FIG. 5 is a schematic diagram of a method for manufacturing a flexible liquid crystal display panel according to an embodiment of the present disclosure.

### DETAILED DESCRIPTION OF THE PREFERRED EMBODIMENTS

The disclosure will be further described in detail with reference to accompanying drawings and preferred embodiments as follows. It should be understood that the specific embodiments described herein are merely employed for explaining and understanding the present invention, but are not limitations thereto.

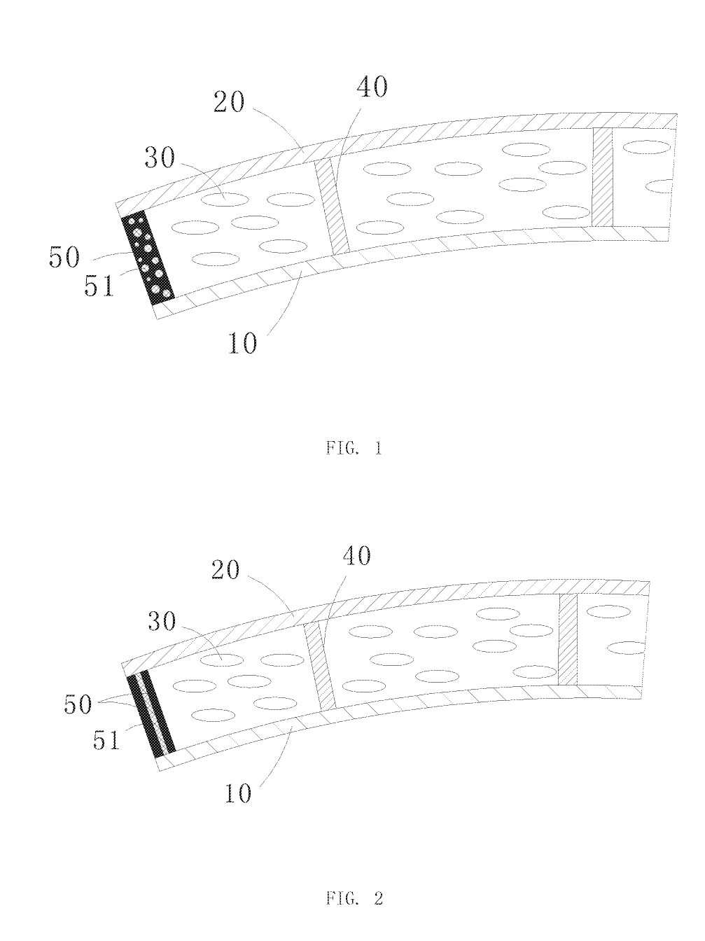

Please refer to FIG. 1, a flexible liquid crystal display panel in one embodiment of the present disclosure comprises a first flexible substrate 10; a second flexible substrate 20, liquid crystals 30, a plurality of pillar spacers 40 and a sealant 50. Wherein the pillar spacers 40 are disposed between the first flexible substrate 10 and the second flexible substrate 20 at intervals, two ends of the pillar spacers 40 are abutting against inner surfaces of the first flexible substrate 10 and the second flexible substrate 20, and the sealant 50 is disposed between the first flexible substrate 10 and the second flexible substrate 20, where the liquid crystals and the pillar spacers 40 are wrapped therein.

The sealant 50 provides an independent closed space for the liquid crystal 30. The main components of the sealant 50 are epoxy resin and acrylic resin, so as to prevent moisture and dust from entering. The sealant 50 is wrapped with a sub-spacer 51. The sub-spacer 51 is a spacer particle which is mixed with the sealing material of the sealant 50 and cured to form an integrated body. The sealant 50 located at the edge of the flexible liquid crystal display panel has both the sealing property and the supporting property of the spacer when compressed. It can keep the cell thickness to a certain extent, prevent the flexible liquid crystal display panel from being torn in the edge during the bending process.

As one embodiment, a thin film transistor array and a color resist are formed on the first flexible substrate 10 facing to the second flexible substrate 20. By forming the thin film transistor array and the color resist on the same layer can eliminate bias of accuracy caused by assembling.

Because the sealant 50 is wrapped with a sub-spacer 51, the surface of the pillar spacer 40 has a sealant, so that the sealant 50 on the periphery has a certain pressure-bearing capability. The internal pillar spacer 40 has good adhesion characteristic, when the flexible liquid crystal display panel bends, the pillar spacer 40 are dispersed in the display area of the flexible liquid crystal display panel, therefore the pillar spacer 40 is not easily disengaged, so as to ensure an uniform cell thickness and good supporting performance of the entire flexible liquid crystal display panel. In addition, the pillar spacer 40 has a larger radial dimension on the second flexible substrate 20 than on the first flexible substrate 10, that is the pillar spacer 40 is thinner on the first flexible substrate 10 end, The light-emitting surface is located on the first flexible substrate 10, and the viewer can hardly see the pillar spacer 40 from the first flexible substrate 10, so as to improve the display effect.

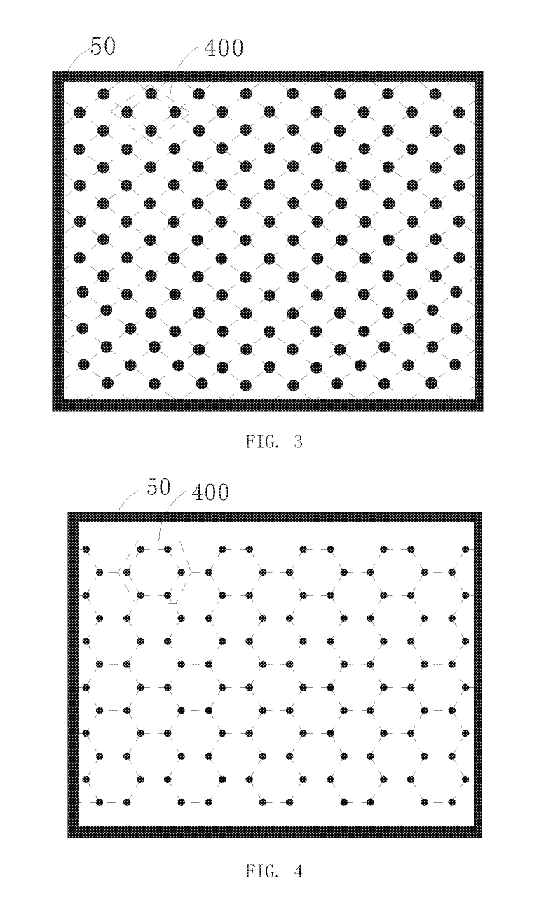

As shown in FIG. 2, the sub-spacers 51 can be a columnar shape, and is wrapped within the sealant 50, also the two ends of the sub-spacer 51 abut against the inner surfaces of the first flexible substrate 10 and the second flexible substrate 20 respectively. The number of the sub-spacers 51 is not limited herein.

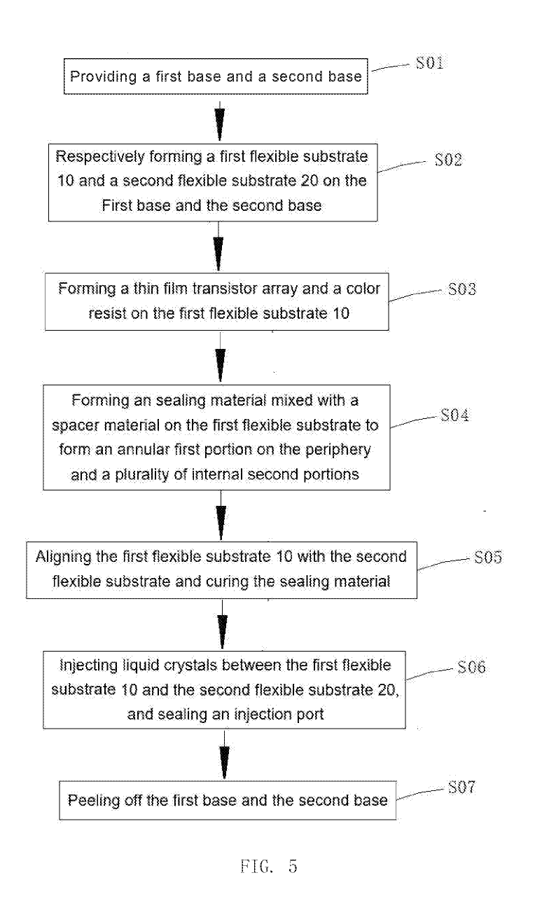

As shown in FIG. 3 and FIG. 4, the pillar spacers 40 enclose a plurality of supporting units 400 adjacent to each other, each of the supporting units 400 comprises at least three pillar spacers 40 adjacent to each, each of two adjacent supporting units 400 shares the plurality of pillar spacers 40 on the same straight line, and at least two sides of an contour line of each of the supporting units 400 are relatively tilted with a length direction and a width direction of the flexible liquid crystal display panel simultaneously.

The supporting unit is a rhombus or a regular polygon, the flexible liquid crystal display panel as shown in FIG. 3, the supporting unit 400 is a rhombus. Every four of the adjacent pillar spacers 40 enclose a rhombus supporting unit 400, each of the two adjacent supporting units 400 shares two pillar spacers 40 on the same straight line. The plurality of pillar spacers 40 enclose a grid pattern, four sides of an contour line of each of the supporting units 400 are relatively tilted with a length direction and a width direction of the flexible liquid crystal display panel simultaneously. The flexible liquid crystal display panel as shown in FIG. 4, the supporting unit 400 is a hexagon, every six of the adjacent pillar spacers 40 enclose a hexagon supporting unit 400, each of the two adjacent supporting units 400 shares two pillar spacers 40 on the same straight line. The plurality of pillar spacers 40 enclose a honeycomb-like pattern, four sides of an contour line of each of the supporting units 400 are relatively tilted with a length direction and a width direction of the flexible liquid crystal display panel simultaneously.

With such a design, when the flexible liquid crystal display panel is bent, the plurality of pillar spacers 40 co-operate in each of the supporting units 400. Since each supporting unit 400 has a plurality of supporting units tilted with the length direction and the width direction of the flexible liquid crystal display panel simultaneously, the pillar spacers 40 disposed on the tiled contour line draw traction to each other. The direction of the force exerts a force components simultaneously in the length direction and the width direction of the flexible liquid crystal display panel, such that the pillar spacer 400 in each of the supporting units cooperatively support the first flexible substrate 10 and the second flexible substrate 20 to jointly resist the bending deformation of the flexible liquid crystal display panel. Therefore, the cell thickness of the flexible liquid crystal display panel is uniform when bending.

In addition, considering that the sealant 50 at the edge portion of the flexible liquid crystal display panel needs to bear greater shearing force, the layout density of the pillar spacer 40 can also be increased at each corner of the sealant 50 near the periphery. That is, at each corner of the sealant 50 near the periphery, the density of the pillar spacer 40 is greater than that of the pillar spacer 40 in other regions.

As shown in FIG. 5, a method of manufacturing a flexible liquid crystal display panel in one embodiment of the present disclosure mainly comprises the following steps:

S01, providing a first base and a second base, wherein the first base and a second base can both adopt glass substrate to offer a flat production surface.

S02, respectively forming a first flexible substrate 10 and a second flexible substrate 20 on the first base and the second base, wherein the first flexible substrate 10 and the second flexible substrate 20 can be made by coating polyimide (PI) on the first substrate and the second substrate, respectively, and then forming by baking. Therefore, the first flexible substrate 10 and the second flexible substrate 20 can be made extremely thin.

S03, forming a thin film transistor array and a color resist on a surface of the first flexible substrate 10 sequentially, the color resist can be made by mask etching process, and exposing a photomask to remove unnecessary color resist.

S04, forming a sealing material mixed with a spacer material on the first flexible substrate 10 to form an annular first portion on the periphery of the first flexible substrate 10 and a plurality of second portions insides the first portion at intervals. Herein, the spacer material is made of flexible spacer particles and is printed on the first flexible substrate 10 by using a printing board after thoroughly mixing sealing material of epoxy resin and acrylic resin. The pattern of the printed area on the edge of the first flexible substrate 10 is a rectangular ring bar. The pattern of the central area is a dot dotted pattern, and the numerous dotted patterns enclose two adjacent diamond or regular polygon patterns. Alternatively, the printed board may have only a dotted pattern of a second portion of the central area to form the pillar spacers 40 correspondingly, and the annular first portion on the periphery may be formed by coating to form the sealant 50 correspondingly.

S05, aligning the first flexible substrate 10 with the second flexible substrate 20 and curing the sealing material to cure the first portion and the second portion to respectively form an sealant 50 and a pillar spacer 40. Correspondingly, the sealant 50 encloses a rectangular sealing strip region, the pillar spacers 40 enclose a plurality of supporting units 400 adjacent to each other, each of the supporting units 400 comprises at least three pillar spacers 40 adjacent to each, each of two adjacent supporting units 400 shares the plurality of pillar spacers 40 on the same straight line, and at least two sides of an contour line of each of the supporting units 400 are relatively tilted with a length direction and a width direction of the flexible liquid crystal display panel simultaneously.

S06, injecting liquid crystals between the first flexible substrate 10 and the second flexible substrate 20, and sealing the injection port.

S07, peeling off the first base and the second base, a laser irradiation can be used to achieve the peeling process, after peeling off the plates, can continue the subsequent cutting, polarizer attaching, chip bonding, and backlight module assembly processes.

In the flexible liquid crystal display panel manufactured by the foregoing method, the sealant and the pillar spacer of the flexible liquid crystal display panel in the present disclosure can be manufactured by the same sealing material. The sealant and the pillar spacer have both sealing ability and supporting ability, so that the flexible liquid crystal display panel can keep a uniform cell thickness after being bent, and there is no risk of tearing in the edge of the sealant. In addition, the arrangement of the pillar can improve the anti-deformation ability of the whole flexible liquid crystal display panel, as well as improve the narrow viewing angle of the flexible liquid crystal display panel.

Finally, it should be noted that the above embodiments are merely illustrative of the technical solutions of the present disclosure and are not intended to be limiting thereof. For the person skilled in the art of the disclosure, without departing from the concept of the disclosure, simple deductions or substitutions can be made and should be included in the protection scope of the disclosure.

What is claimed is:

1. A flexible liquid crystal display panel, comprising a first flexible substrate, a second flexible substrate, liquid crystals, a plurality of pillar spacers disposed between the first flexible substrate and the second flexible substrate, and a sealant disposed between the first flexible substrate and the second flexible substrate for sealing the liquid crystals and the pillar spacers therein, two ends of the pillar spacers abutting against inner surfaces of the first flexible substrate and the second flexible substrate, and a sub-spacer being wrapped within the sealant.

2. The flexible liquid crystal display panel according to claim 1, wherein the sub-spacer is a spacer particle and is integrally formed with a material of the sealant.

3. The flexible liquid crystal display panel according to claim 1, wherein the sub-spacer has a columnar shape and has two ends abutting against the inner surfaces of the first flexible substrate and the second flexible substrate respectively.

4. The flexible liquid crystal display panel according to claim 3, wherein a thin film transistor array and a color resist are disposed on a surface of the first flexible substrate facing the second flexible substrate.

5. The flexible liquid crystal display panel according to claim 4, wherein a radial dimension of the pillar spacer on the second flexible substrate is greater than that on the first flexible substrate.

6. The flexible liquid crystal display panel according to claim 1, wherein the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.

7. The flexible liquid crystal display panel according to claim 6, wherein the supporting unit is a rhombus or a regular polygon.

8. The flexible liquid crystal display panel according to claim 2, wherein the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.

9. The flexible liquid crystal display panel of claim 8, wherein the supporting unit is a rhombus or a regular polygon.

10. The flexible liquid crystal display panel according to claim 3, wherein the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.

11. The flexible liquid crystal display panel of claim 10, wherein the supporting unit is a rhombus or a regular polygon.

12. The flexible liquid crystal display panel according to claim 4, wherein the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.

13. The flexible liquid crystal display panel of claim 12, wherein the supporting unit is a rhombus or a regular polygon.

14. The flexible liquid crystal display panel according to claim 5, wherein the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.

15. The flexible liquid crystal display panel of claim 14, wherein the supporting unit is a rhombus or a regular polygon.

16. A method of manufacturing a flexible liquid crystal display panel, comprising:
providing a first base and a second base;
respectively forming a first flexible substrate and a second flexible substrate on the first base and the second base;
forming an sealing material mixed with a spacer material on the first flexible substrate to form an annular first portion on the periphery of the first flexible substrate and a plurality of second portions insides the first portion at intervals;
aligning the first flexible substrate with the second flexible substrate and curing the sealing material to cure the first portion and the second portion to respectively form a sealant and a pillar spacer;
injecting liquid crystals between the first flexible substrate and the second flexible substrate, and sealing an injection port; and
peeling off the first base and the second base.

17. The method of manufacturing a flexible liquid crystal display panel according to claim 16, wherein the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.

18. The method of manufacturing a flexible liquid crystal display panel according to claim 16, wherein a material of the pillar spacer is a spacer particle.

19. The method of manufacturing a flexible liquid crystal display panel according to claim 18, wherein the pillar spacers enclose a plurality of supporting units adjacent to each other, each of the supporting units comprises at least three pillar spacers adjacent to each, each of two adjacent supporting units shares the plurality of pillar spacers on the same straight line, at least two sides of an contour line of each of the supporting units are relatively tilted with a length direction and a width direction of the flexible liquid crystal display panel simultaneously.
